(19) United States
(12) Patent Application Publication
(10) Pub. No.: US 2017/0315842 A1
(43) Pub. Date: Nov. 2, 2017

(54) RESOURCE CONSUMING TASKS SCHEDULER

(71) Applicant: HEWLETT PACKARD ENTERPRISE DEVELOPMENT LP, Houston, TX (US)

(72) Inventors: Marina Lyan, Modiin (IL); Pavel Danichev, Yehud (IL); Elad Kadosh, Yehud (IL)

(21) Appl. No.: 15/523,647

(22) PCT Filed: Oct. 30, 2014
(86) PCT No.: PCT/US2014/063106

§ 371 Date: May 1, 2017

(51) Int. Cl. G06F 9/48

(52) U.S. Cl. CPC G06F 9/4881

(57) ABSTRACT

In one implementation, a system for resource consuming tasks scheduling includes a metrics engine to identify a plurality of metrics based on a task to be scheduled, a utilization engine to generate a compiled representation of combined resource values over a period of time, wherein the combined resource values are based on a combination of the plurality of metrics;, an identification engine to identify common lows of resource utilization for the plurality of metrics based on the generated representation, and a schedule engine to schedule the task for a time that corresponds to the identified common lows of resource utilization.

### BACKGROUND

Big data analytics can include collecting and storing relatively large quantity of data relating to a plurality of different systems. Utilizing the relatively large quantity of data being stored can be difficult. Many systems utilize administrators to execute applications that perform a number of tests and/or gather data relating to the system. In some cases the applications can utilize resources of the system and therefore can optimally be administered at a time when the applications do not interfere with existing programs and/or applications running on the system.

### BRIEF DESCRIPTION OF THE DRAWINGS

FIG. 1 illustrates a diagram of an example of a system for resource consuming tasks scheduler according to the present disclosure.

FIG. 2 illustrates a diagram of an example computing device according to the present disclosure.

FIG. 3 illustrates a diagram of an example of a system for a resource consuming tasks scheduler according to the present disclosure.

FIG. 4 illustrates a representation for resource consuming tasks scheduling according to the present disclosure.

FIG. 5 illustrates a flow chart for resource consuming tasks scheduling according to the present disclosure.

FIG. 6 illustrates a combined representation for resource consuming tasks scheduling according to the present disclosure.

FIG. 7 illustrates a chart for resource consuming tasks scheduling according to the present disclosure.

FIG. 8 is a flow chart of an example of a method for resource consuming tasks scheduling according to the present disclosure.

### DETAILED DESCRIPTION

A computing system can be operating a plurality of different applications over a period of time (e.g., one week, one month, one year, etc.). For example, the computing system can operate a variety of software as a service (SaaS) applications such as Agile Manager (AGM) and Project & Portfolio Management (PPM). The computing system can include a number of metric monitors to monitor the metrics (e.g., resource metrics) utilized by the applications. In some embodiments, the plurality of metrics can include business metrics (e.g., quantity of users utilizing the computing system, synthetic transactions being executed on the computing system, etc.) and system metrics (e.g., IT metrics, resource metrics, etc.). For example, the system metrics can include a quantity of physical resources consumed by the task to be scheduled. As used herein, the task and/or number of tasks include operations that utilize resources (e.g., physical resources, logical resources, etc.) of a computing system.

The computing system can require that a number of tasks be performed to update and/or check the computing system. For example, an administrator for the computing system may upgrade the computing system and/or run an antivirus task. The number of tasks can utilize a particular quantity of resources from the computing system. As used herein, metrics represent resource utilization for a number of different physical and logical resources associated with a computing system. That is, metrics can represent resource utilization data over a period of time. In some embodiments, the number of tasks are services and/or applications to be operated on the computing system.

A resource consuming tasks scheduler can be utilized to compare a plurality of identified metrics that are associated with a particular task to be scheduled by a task scheduler. For example, the resource consuming tasks scheduler can be utilized to compare central processing unit (CPU) consumption, memory consumption, time of operation, number of users, and/or database consumption for a particular application to be performed at a particular time. The identified metrics can be metrics of a task to be scheduled that are relatively important for performance of the task. The identified metrics can be monitored by the resource consuming tasks scheduler when the computing system is performing functions over a particular time period. Monitoring the identified metrics can give an indication of when the computing system is utilizing a relatively high quantity of the metrics and an indication of when the computing system is utilizing a relatively low quantity of the metrics.

As described herein, the computing system can run a plurality of different applications. Each of the plurality of different applications can utilize a different quantity of resources at different times. For example, the system can run a first application that utilizes a relatively high quantity of resources at a first time and run a second application that utilizes a relatively low quantity of resources at the first time. In this example, the first application and the second application can be monitored to determine time segments (e.g., portions of time) where the first application and the second application are utilizing a relatively low quantity of the resources and/or metrics that are utilized by a task to be performed.

Tasks can be scheduled during a time when the task may not interfere with applications operating on the computing system by monitoring a plurality of different applications over a period of time for a plurality of identified metrics that are associated with the task to be scheduled. As described further herein, the resource consuming tasks scheduler can be advantageous over previous methods by incorporating multiple metrics from the task to be scheduled into a compiled representation that includes monitored resource consumption from a plurality of different applications running on the computing system over a period of time. The compiled representation can be utilized to identify a number of continuous segment intervals that represent time segments with relatively low resource consumption for the metrics. The task can then be scheduled during at least one of the number of continuous segment intervals.

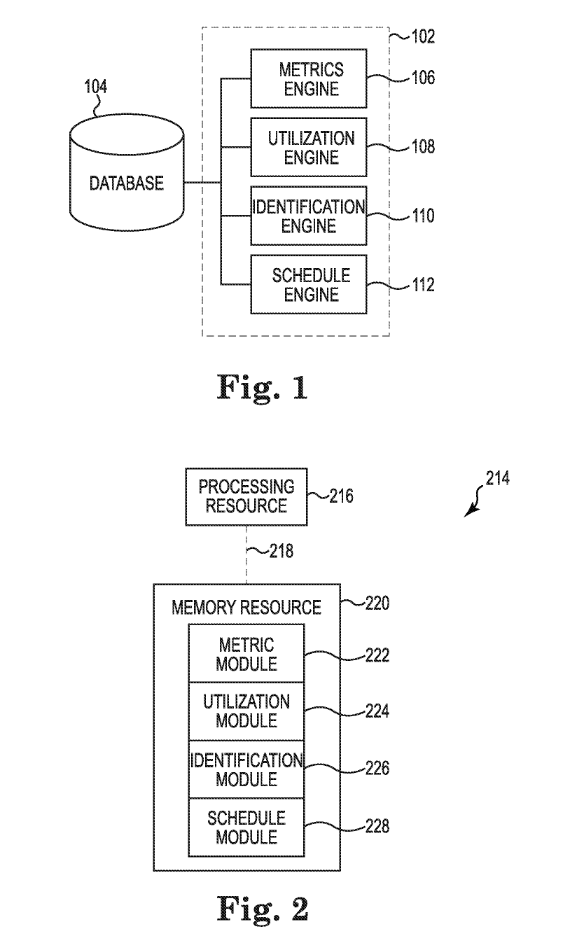

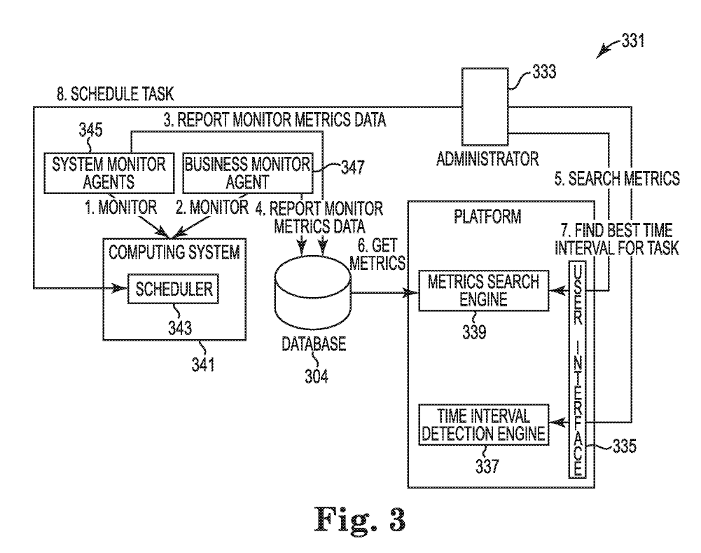

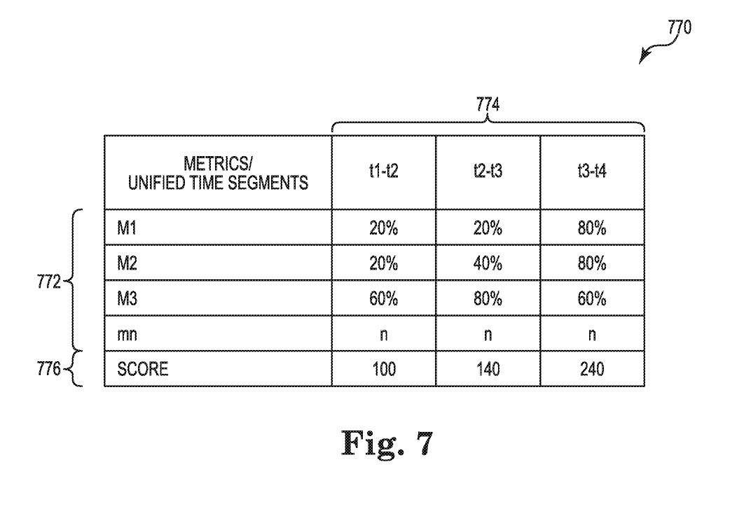

FIGS. 1 and 2 illustrate examples of system 100 and computing device 214 according to the present disclosure. FIG. 1 illustrates a diagram of an example of a system 100 for a resource consuming tasks scheduler according to the present disclosure. The system 100 can include a database 104, a resource consuming tasks scheduler system 102, and/or a number of engines (e.g., metrics engine 106, utilization engine 108, identification engine 110, schedule engine 112). The resource consuming tasks scheduler system 102 can be in communication with the database 104 via a communication link, and can include the number of engines (e.g., metrics engine 106, utilization engine 108, identification engine 110, schedule engine 112). The resource consuming tasks scheduler system 102 can include additional or fewer engines that are illustrated to perform the various functions as will be described in further detail in connection with FIGS. 3-7.

The number of engines (e.g., metrics engine 106, utilization engine 108, identification engine 110, schedule engine 112) can include a combination of hardware and programming, but at least hardware, that is configured to perform functions described herein (e.g., identify a plurality of metrics based on a task to be scheduled, generate a representation of resource utilization for the plurality of metrics over a time period, identify common lows of resource utilization for the plurality of metrics based on the generated representation, schedule the task for a time that corresponds to the identified common lows of resource utilization, etc.). The programming can include program instructions (e.g., software, firmware, etc.) stored in a memory resource (e.g., computer readable medium, machine readable medium, etc.) as well as hard-wired program (e.g., logic).

The metrics engine 106 can include hardware and/or a combination of hardware and programming, but at least hardware, to identify a plurality of metrics (e.g., physical resources, logical resources, etc.) based on a task to be scheduled. Identifying the plurality of metrics based on a task to be scheduled can include identifying resource metrics that can be utilized by the task to be scheduled. For example, resources that are utilized by performing a particular update and/or performing a particular anti-virus scan. The metrics can also include an estimated quantity of time (e.g., estimated time segment, unified time segment, etc.) to perform the particular task.

The utilization engine 108 can include hardware and/or a combination of hardware and programming, but at least hardware, to generate a compiled representation of combined resource values over a period of time, wherein the combined resource values are based on a combination of the plurality of metrics. The representation can include a digital representation of a graph. The representation can include a quantity of resources utilized by applications of a computing system over a period time. The representation can display the quantity of resources for each of a plurality of applications of the computing system over the period of time.

In some embodiments, the utilization engine 108 can generate the representation of resource utilization from monitored resource utilization for each of the applications running on the computing system. The utilization engine 108 can be utilized to generate the representation based on selected real user monitoring (RUM) metrics being utilized by applications running on the computing system.

The identification engine 110 can include hardware and/or a combination of hardware and programming, but at least hardware, to identify common lows of resource utilization for the plurality of metrics based on the generated representation. Identifying common lows of resource utilization can include identifying time segments on the representation where the plurality of applications are utilizing a relatively low quantity of resources/metrics compared to other time segments of the generated representation. That is, identifying common lows can include identifying time segments where at least a portion of applications are operating with a relatively low quantity of resources.

The schedule engine 112 can include hardware and/or a combination of hardware and programming, but at least hardware, to schedule the task for a time that corresponds to the identified common lows of resource utilization. Scheduling the task for a time that corresponds to the identified common lows can include determining a particular time segment for a particular day within a particular week or particular month from the representation. The task can then be scheduled for a future date and time that corresponds to the particular time segment and the particular day. For example, the identified common lows can occur on a Tuesday between 9:00 PM and 11:00 PM. In this example, the task can then be scheduled on a different Tuesday between 9:00 PM and 11:00 PM.

The system 100 can be utilized to automatically schedule tasks during times where a low quantity of resources, that can be utilized by the tasks, are being utilized by existing applications of a computing system. The system 100 can be utilized to identify a plurality of different metrics based on the task to be scheduled and monitoring the plurality of different metrics to determine when a common low quantity of metrics are being utilized by the existing applications of the computing system. In some embodiments, a representation can be generated to represent the quantity of resources utilized by each of the existing applications.

The system 100 can also generate a compiled representation of the quantity of resources utilized by each of the existing applications. The system 100 can be advantageous over previous methods and systems by utilizing a plurality of metrics based on the task to be scheduled and generating the compiled representation to determine common low quantity of metrics being utilized to determine a time segment to schedule the task.

FIG. 2 illustrates a diagram of an example computing device 214 according to the present disclosure. The computing device 214 can utilize software, hardware, firmware, and/or logic to perform functions described herein.

The computing device 214 can be any combination of hardware and program instructions configured to share information. The hardware, for example, can include a processing resource 216 and/or a memory resource 220 (e.g., computer-readable medium (CRM), machine readable medium (MRM), database, etc.). A processing resource 216, as used herein, can include any number of processors capable of executing instructions stored by a memory resource 220. Processing resource 216 may be implemented in a single device or distributed across multiple devices. The program instructions (e.g., computer readable instructions (CRI)) can include instructions stored on the memory resource 220 and executable by the processing resource 216 to implement a desired function (e.g., identify a plurality of metrics based on a task to be scheduled, generate a representation of each of the plurality of metrics over a time period, generate a compiled representation that combines each of the plurality of metrics over the time period, wherein the compiled representation includes a percentile value representation, identify a number of continuous segment intervals from the compiled representation, schedule the task during at least one of the continuous segment intervals, etc.).

The memory resource 220 can be in communication with a processing resource 216. A memory resource 220, as used herein, can include any number of memory components capable of storing instructions that can be executed by processing resource 216. Such memory resource 220 can be a non-transitory CRM or MRM. Memory resource 220 may be integrated in a single device or distributed across multiple devices. Further, memory resource 220 may be fully or partially integrated in the same device as processing resource 216 or it may be separate but accessible to that device and processing resource 216. Thus, it is noted that the computing device 214 may be implemented on a participant device, on a server device, on a collection of server devices, and/or a combination of the participant device and the server device.

The memory resource 220 can be in communication with the processing resource 216 via a communication link (e.g., a path) 218. The communication link 218 can be local or remote to a machine (e.g., a computing device) associated with the processing resource 216. Examples of a local communication link 218 can include an electronic bus internal to a machine (e.g., a computing device) where the memory resource 220 is one of volatile, non-volatile, fixed, and/or removable storage medium in communication with the processing resource 216 via the electronic bus.

A number of modules (e.g., metrics module 222, utilization module 224, identification module 226, schedule module 228) can include CRI that when executed by the processing resource 216 can perform functions. The number of modules (e.g., metrics module 222, utilization module 224, identification module 226, schedule module 228) can be sub-modules of other modules. For example, the utilization module 224 and the identification module 226 can be sub-modules and/or contained within the same computing device. In another example, the number of modules (e.g., metrics module 222, utilization module 224, identification module 226, schedule module 228) can comprise individual modules at separate and distinct locations (e.g., CRM, etc.).

Each of the number of modules (e.g., metrics module 222, utilization module 224, identification module 226, schedule module 228) can include instructions that when executed by the processing resource 216 can function as a corresponding engine as described herein. For example, the metrics module 222 can include instructions that when executed by the processing resource 216 can function as the metrics engine 106. In another example, the utilization module 224 can include instructions that when executed by the processing resource 216 can function as the utilization engine 108. In another example, the identification module 226 can include instructions that when executed by the processing resource 216 can function as the identification engine 110. In another example, the schedule module 228 can include instructions that when executed by the processing resource 216 can function as the schedule engine 112.

FIG. 3 illustrates a diagram of an example of a system 331 for a resource consuming tasks scheduler according to the present disclosure. The system 331 can be utilized to more accurately schedule a number of tasks so that the number of tasks do not interfere with applications utilizing resources on a computing system 341. For example, a number of applications can be operating on the computing system 341 and a number of tasks can be scheduled to be executed on the computing system 341 when the number of applications are utilizing a relatively low quantity of resources from the computing system 341.

The system 331 can include a system monitor 345 and a business monitor 347. The system monitor 345 can be utilized to monitor a number of system metrics (e.g., IT metrics, resource metrics, CPU metrics, memory metrics, etc.) that are being executed on the computing system 341. For example, the system metrics can include a quantity of physical resources consumed by applications running on the computing system 341. The business monitor 347 can be utilized to monitor a number of business metrics (e.g., quantity of users utilizing the computing system, synthetic transactions being executed on the computing system, etc.). For example, the number of business metrics can include a quantity of users logged into the computing system 341. In some embodiments, the business monitor 347 can include a real user monitor (RUM) to determine user behavior on the computing system 341. For example, the real user monitor can determine a quantity of users logged into the computing system 341 over a particular time period.

The system monitor 345 and the business monitor 347 can store the monitored system and business metrics in a database 304 (e.g., database 204, Vertica database, etc.). A platform 335 can retrieve the stored system and business metrics from the database 304 via a metrics search engine 339. The platform 335 can include a big data platform that can utilize the relatively large quantity of system metrics and business metrics to determine a number of time segments for scheduling a number of tasks.

The platform 335 can include a metrics search engine 339 to search the database 304 for system metrics and business metrics over a particular time period. As described herein, the system metrics and business metrics can be analyzed for the time period to determine a number of time segments within the time period where a relatively low quantity of resources are being utilized based on the system and business metrics from the time period.

In some embodiments, the metrics search engine 339 can be executed by an administrator 333 to search for particular system metrics and/or business metrics for a particular time period. For example, the administrator can input a particular time period (e.g., time window, quantity of time, etc.) into a user interface of the platform 335 and designate particular system metrics and/or business metrics to search within the database 304. In this example, the metrics search engine 339 can retrieve the metrics input by the administrator from the database 304.

The retrieved system and business metrics from the metrics search engine 339 can be analyzed by the time interval detection engine 337 to determine a number of time segments with similar resource utilization by applications on the computing system 341. In some embodiments, the time interval detection engine 337 can determine a number of low utilization time segments. For example, the time interval detection engine 337 can analyze the number of time segments and determine a number of time segments with a relatively low resource utilization based on the system and/or business metrics.

The number of time segments and/or the number of low utilization time segments can be displayed on the user interface of the platform 335. The administrator 333 can determine a time segment from the number of time segments and/or the number of low utilization time segments. In some embodiments, the administrator 333 can select a time segment that includes a quantity of available resources that will be capable of performing a particular task to be scheduled. In addition, the administrator 333 can select a time segment from the number of low utilization time segments that includes a duration of time that will enable the task to be scheduled to be completed prior to the selected time segment ending.

The administrator can utilize a task scheduler 343 to schedule the task during the selected time segment. As described herein, the time segment can be utilized to determine a future time segment that may be utilized to schedule a task so that the task will have enough available resources to execute and/or not interfere with applications that are running on the computing system 341.

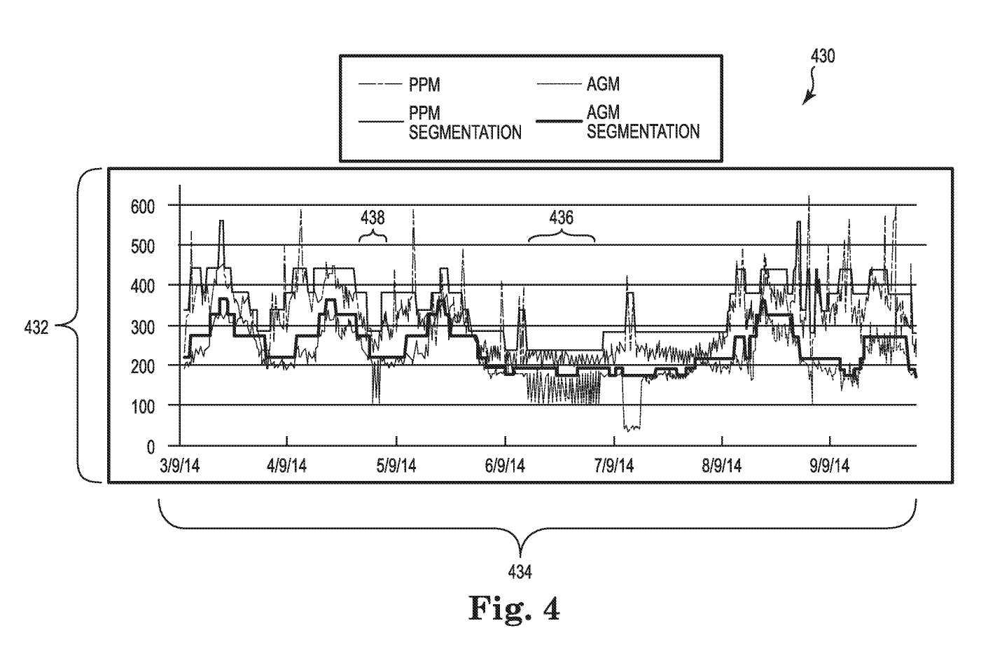

FIG. 4 illustrates a representation 430 for resource consuming tasks scheduling according to the present disclosure. The representation 430 can be a digital graphical representation of resource utilization of identified metrics. As described herein, the particular resources and/or metrics for the representation 430 can be based on a task to be scheduled. The metrics for a particular task can be based on particular resource requirements of the particular task. For example, a particular task may utilize a particular quantity of CPU resources, memory resources, and/or time resources of the computing system.

The representation 430 can include a resource utilization for a plurality of applications that are being utilized by a computing system. For example, the representation 430 can include a digital representation of a quantity of users 432 utilizing a PPM application and an AGM application. The representation 430 can include the quantity of users utilizing the plurality of applications over a particular time period 434. In some embodiments, the representation 430 can include application utilization for a particular organization. In certain embodiments, the particular organization can have users utilizing the plurality of applications at a plurality of different locations. That is, the representation 430 can be digital representation of resource utilization for applications that are being utilized at a plurality of different locations.

In some embodiments, the representation 430 can include an actual data representation of the quantity of users 432 utilizing the plurality of applications. In addition, the representation 430 can include a segmentation representation of the quantity of users 432 utilizing the plurality of applications. The segmentation representation can be a normalization of the actual data representation. The normalization can include removing a number of outlier values from the actual data representation and generating a number of time segments at a particular value based on the actual data representation.

The time segments can be portions of time from the time period 434 where the quantity of users 432 utilizing an application is relatively the same. For example, time segment 436 can represent a portion of time where the quantity of users 432 utilizing the AGM application is approximately 250 units and the quantity of users 432 utilizing the PPM application is approximately 200 units. The time segments can be analyzed to determine a number of low utilization time segments (e.g., common lows of resource utilization, etc.) where the plurality of applications have a relatively low quantity of users 432 utilizing the plurality of applications. For example, time segment 438 and time segment 436 can be identified as low utilization time segments since both the PPM and AGM utilization are relatively low within time segment 438 and time segment 436.

The representation 430 can be utilized to predict future time segments that have a relatively low utilization. For example, time segment 436 is a portion of time between Saturday Sep. 6, 2014 and Sunday Sep. 7, 2014. In this example, a task can be scheduled for a time segment between a Saturday and Sunday.

The representation 430 can be altered to include a number of different time periods 434 (e.g., a day, a week, a month, a year, etc.). In addition, the representation can also include a number of different resource utilization units 432 (e.g., different metrics, etc.). In some embodiments the resource utilization units 432 can be based on resources that can be utilized by a task to be scheduled during a time segment with a relatively low resource utilization. The representation 430 can be utilized to more accurately schedule a number of tasks so that the number of tasks do not interfere with applications utilizing resources on a computing system.

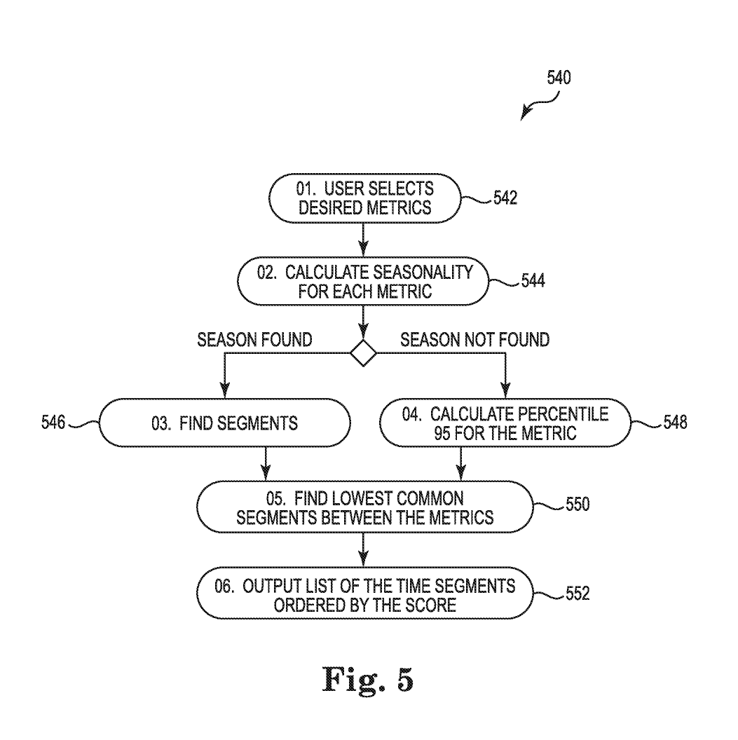

FIG. 5 illustrates a flow chart 540 for resource consuming tasks scheduling according to the present disclosure. The flow chart 540 can represent a number of steps for resource consuming tasks scheduling according to the present disclosure. The flow chart 540 can start by selecting a number of metrics at 542. As described herein, selecting the number of metrics can be based on a task to be scheduled. The task can include an update to a computing system and/or other task that may not be normal function of an organization, but is necessary for a computing system.

The metrics can include a number of resources that can be utilized by the task to be scheduled. For example, the task to be scheduled can be an anti-virus scan. In this example, the anti-virus scan may require a CPU utilization and memory utilization over a segment of time. In this example, the metrics can include CPU utilization and memory utilization for the computing system over a period of time. The CPU utilization and memory utilization of the computing system can be monitored for a plurality of different applications over the period of time (e.g., one week, one month, etc.).

The flow chart 540 can include calculating a seasonality for each metric at 444. Calculating the seasonality can include determining a number of trends that appear to repeat in a cyclical manner. For example, calculating a seasonality for a work week can result in identifying that particular patterns occur during the days of Monday through Friday. Calculating the seasonality can include eliminating a number of outlier values from the monitored metrics and segmenting (e.g., normalizing) the monitored metrics as described herein. The number of outliers can include data that is misrepresentative of the monitored metrics as a whole and/or data that appears to be incorrect and/or corrupted.

The flow chart 540 can determine if a seasonality can be calculated for each metric. If a seasonality is found the flow chart 540 can move to finding segments at 546. As described herein, the segments can be determined by identifying segments of a representation (e.g., representation 430 as referenced in FIG. 4) with relatively low resource utilization for each metric and for each of a plurality of applications. In some embodiments, a plurality of segments are identified and categorized based on a corresponding resource utilization value.

If the seasonality is not found the flow chart 540 can move to calculating a percentile for the metric at 548. Calculating a percentile for the metric at 548 can include combining the monitored resource utilization data (e.g., metric resource data, monitored metrics, etc.) into a single seasonality cycle. The seasonality cycle can be utilized to determine a number of segments by comparing the seasonality cycle to a number of different percentiles (e.g., 20 percentile, 40 percentile, 95 percentile, etc.) from a generated compiled graphical representation. Segments can be identified when the seasonality cycle is below the percentile value. In addition, the outliers can identified when the seasonality cycle is above the percentile value. Calculating the percentile for the metric at 548 is described in further detail at FIG. 5.

When the segments are found at either 546 or 548 the flow chart 540 can move to finding a lowest common segment between the metrics at 550. The lowest common segment between the metrics can include an identified segment with a relatively low resource utilization from the metrics for each of the monitored applications of the computing system.

When the segments with a relatively low resource utilization are determined at 550 the flow chart 540 can move to outputting a list of time segments ordered by a score. The list of time segments can be categorized based on the determined score for each corresponding identified segments. The score can identify how acceptable a particular time segment is for running the task to be scheduled. For example, a relatively high score can be assigned to a segment that has a relatively high resource utilization for resource metrics associated with the task to be scheduled. In some embodiments, the score can be a sum of percentage utilization of each of the metrics.

The flow chart 540 can be utilized to determine a time segment to schedule a task. In addition, the flow chart 540 can be utilized to determine a time segment that will likely have additional resources to perform the task without interfering with running applications on the computing system. For example, the flow chart 540 can be utilized to identify a time segment where the computing system will have enough additional resources to perform the task to be schedule without interrupting service to the applications running on the computing system.

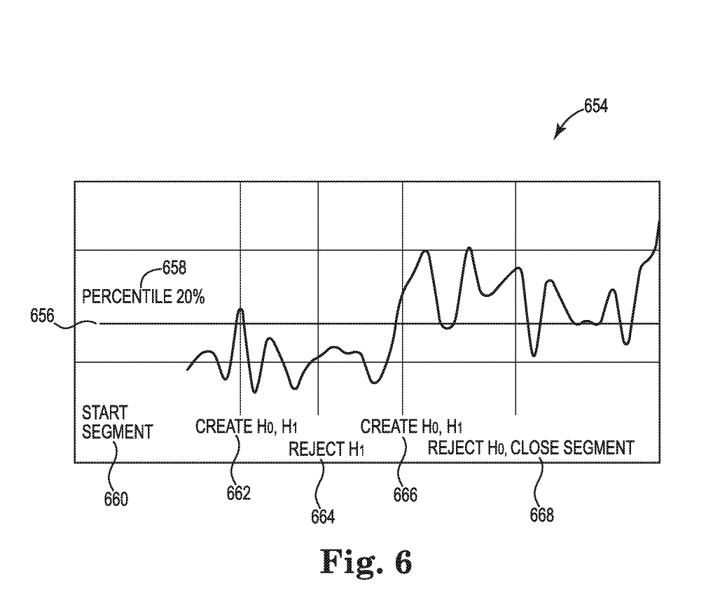

FIG. 6 illustrates a combined representation 654 for resource consuming tasks scheduling according to the present disclosure. The combined representation 654 can be generated by combining a plurality of monitored resource metrics determined based on a task to be scheduled. The combined representation 654 can include a percentile 658 and a representative line 656 indicating where the combined resource values are compared to the percentile 658. In some embodiments, the percentile of resource utilization can be 20 percent utilization of resources.

A segment can be identified utilizing the combined representation 654. The start of a segment 660 can be identified when the values are below the representative line 656 of the percentile 656. A first and second hypothesis can be created at 662 (e.g., H0, H1). In some embodiments, the first hypothesis (H0) can denote a temporal outlier series within a segment. The first hypothesis can be rejected if an outlier's percentage of the current series is greater than the 95 percentile. When the first hypothesis (H0) is rejected a segment can be added to the output. The second hypothesis (H1) can denote an end of a segment. The second hypothesis can be rejected if the percentage of an outlier series is below the 25 percentile. That is, the usage percentage of each of the metrics for the time period can be compared to the percentile value for each combined representation 654 with the number of different percentile values.

The percentile value can be utilized to separate the usage percentage of the number of metrics into two areas (e.g., area below the percentile value and area above the percentile value). That is, the metric values can be split into values that are below the percentile value representation and values that are above the percentile value representation. In some embodiments, there can be a number of outliers that are identified. The number of outliers can be categorized into at least a number of temporal outlier series and a number of segment ends.

In some embodiments, a combined representation 654 can be generated for a plurality of different percentiles. For example, a first combined representation 654 can be generated for the 95 percentile and a second combined representation 654 can be generated for the 20 percentile. The first and second hypothesis can be utilized to determine a number of segments for each of the plurality of different percentiles.

The combined representation 654 can be utilized to reject the second hypothesis at 664 since the values on the combined representation 654 is less than the 25 percentile. In addition, a new set of hypotheses can be created at 666 when the values are above the 20 percentile. When the values are above the 20 percentile the first hypothesis and second hypothesis can be checked again. At 668 the first hypothesis (H0) can be rejected since the values are consistently above the 25 percentile. In some embodiments, when the first hypothesis is rejected, the segment that is used to reject the first hypothesis can be added to a list of segments that could potentially be a lowest segment.

The combined representation 654 can be utilized to identify a list of segments that could potentially be utilized to schedule future tasks. For example, the segments from the combined representation 654 can be utilized to predict future resource utilization during particular time segments. The combined representation 654 can be advantageous over previous systems and methods by utilizing a plurality of metrics from a plurality of different applications being run on a computing system.

FIG. 6 illustrates a chart 670 for resource consuming tasks scheduling according to the present disclosure. The chart 670 can include a plurality metrics 672 that are determined based on a task to be scheduled. For example the plurality of metrics 672 can be metrics that the task can utilize when executed by the computing system.

The chart 670 can include a number of time segments 674. The number of time segments 674 can be unified time segments for a particular time period. For example, the particular time period can be a 7 day period. In this example, each unified time segment can be a period of 24 hours. For each metric a percentile can be determined for each unified time segment. For example, for a metric 1 (m1) a percentile can be determined for each unified time segment. In some embodiments, the time segment can be a predicted time consumption of the task to be scheduled. In some embodiments, the unified time segments can include a number of start times and a number of end times for the task to be scheduled over the period of time. Thus, the chart 670 can include a percentile value representation for each of the number of start times and the number of end times.

The chart 670 can include a score 676 for each unified time segment. The score 676 can represent a how acceptable a particular unified time segment is for scheduling the task. In some embodiments, the score 676 can be a value of the sum of the percentile values for each of the plurality of metrics 672. The score can indicate a lowest unified segment that utilizes the least amount of resources for the plurality of metrics 672. A list can be generated based on the score 676 to determine a unified time segment that can be utilized to select a time segment for the task to be scheduled. The chart 670 can be advantageous for selecting a time segment for the task to be scheduled because it utilizes the plurality of metrics 672 to select the time segment. In some embodiments, the chart can be utilized to generate the combined representation. That is, the resource utilization percentage for each of the number of metrics 672 can be utilized to percentage. In some embodiments, the score 676 can be utilized to generate the combined representation by plotting the score vs time with the particular percentile representation.

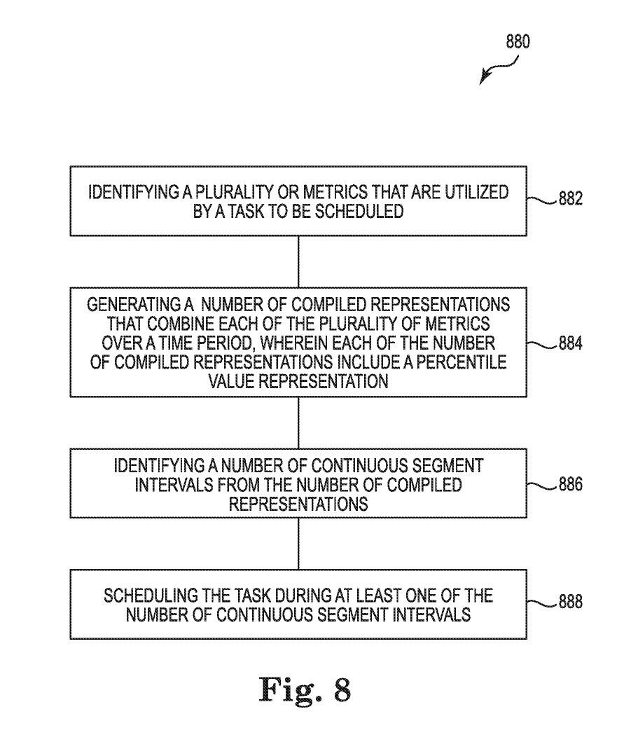

FIG. 8 is a flow chart of an example of a method 880 for resource consuming tasks scheduling according to the present disclosure. The method 880 can be executed by a system 100 as referenced in FIG. 1 and/or a computing device 214 as referenced in FIG. 2. The method 880 can provide a better representation of time segments that are available for scheduling tasks by utilizing a plurality of different metrics over the course of a time period. As described herein, the plurality of different metrics can be utilized to monitor resource utilization for a plurality of different applications being run on a computing system where the task is to be scheduled.

At box 882, the method 880 can include identifying a plurality of metrics that are utilized by a task to be scheduled. As described herein, identifying a plurality of metrics that are utilized by the task to be scheduled can include determining what quantity of resources are needed to execute the task on a computing system. For example, the plurality of metrics can include CPU utilization, memory utilization, time utilization, among many other resource consumption metrics that are associated with the task to be scheduled.

At box 884, the method 880 can include generating a number of compiled representations that combine each of the plurality of metrics over a time period, wherein each of the number of compiled representations include a percentile value representation. Generating a number of compiled representations can include generating a compiled representation for a number of percentile value representations as described herein in reference to FIG. 6. The compiled representations can compile the metrics and the resources consumed by applications throughout the time period for each of the metrics.

The compiled representation can be utilized to identify a number of time segments with corresponding resource utilization for each of the plurality of metrics. The identified number of time segments with similar resource utilization can be utilized to determine a number of lowest time segments. The determined number of lowest time segments are time segments that include a number of applications utilizing a relatively quantity of resources associated with the identified metrics. In some embodiments, the determined number of lowest time segments can be analyzed to determine a time segment with a lowest resource utilization from the number of lowest time segments.

At box 886, the method 880 can include identifying a number of continuous segment intervals from the number of compiled representations. Identifying the number of continuous segment intervals for the number of compiled representations can include identifying continuous segment intervals with a relatively low resource utilization. For example, identifying the continuous segment intervals can include identifying a number of continuous segments that are identified as lowest time segments. In some embodiments, identifying the number of continuous segment intervals can include identifying segments of the number of compiled representations that transition from a position below the percentile value representation of a combined representation to a position above the percentile value representation of the combined representation.

At box 888, the method 880 can include scheduling the task during at least one of the number of continuous segment intervals. Scheduling the task during at least one of the number of continuous segment intervals can include scheduling the task during the same time segment on a future as the at least one of the number of continuous segment intervals. For example, the at least one of the number of continuous segment intervals can include a particular portion of time during a Saturday, the task can be scheduled on a following Saturday during the same particular portion of time. The method 880 can be advantageous over previous methods of scheduling tasks since multiple metrics are utilized to identify time segments with relatively low resource utilization for the multiple metrics.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor. Further, as used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed is:

1. A system for resource consuming tasks scheduling, comprising:
a metrics engine to identify a plurality of metrics based on a task to be scheduled;
a utilization engine to generate a compiled representation of combined resource values over a period of time, wherein the combined resource values are based on a combination of the plurality of metrics;
an identification engine to identify common lows of resource utilization for the plurality of metrics based on the generated compiled representation; and
a schedule engine to schedule the task for a time that corresponds to the identified common lows of resource utilization.

2. The system of claim 1, wherein the plurality of metrics include business metrics and system metrics.

3. The system of claim 2, wherein the system metrics comprise a quantity of physical resources consumed by the task to be scheduled.

4. The system of claim 1, wherein the compiled representation of resource utilization includes a single representation of the plurality of metrics over the time period with a percentile value representation.

5. The system of claim 4, wherein the compiled representation of resource utilization is split into values that are below the percentile value representation and values that are above the percentile value representation.

6. The system of claim 1, comprising the utilization engine to identify a number of outliers from the compiled representation of resource utilization.

7. The system of claim 6, wherein the number of outliers are categorized into at least one of: a temporal outlier series and a segment end.

8. A non-transitory computer readable medium storing instructions executable by a processing resource to cause a controller to:
identify a plurality of metrics based on a task to be scheduled;
generate a representation of each of the plurality of metrics over a time period;
generate a compiled representation that combines each of the plurality of metrics over the time period, wherein the compiled representation includes a percentile value representation;
identify a number of continuous segment intervals from the compiled representation; and
schedule the task during at least one of the continuous segment intervals.

9. The medium of claim 8, comprising instructions to generate a table comprising a number of start times and end times for the task over the time period.

10. The medium of claim 9, wherein the table comprises each metric consumption of resources for each of the number of start times and end times.

11. The medium of claim 9, wherein the table comprises a percentile value representation for each of the number of start times and end times.

12. A method for resource consuming tasks scheduling, comprising:
identifying a plurality of metrics that are utilized by a task to be scheduled;
generating a number of compiled representations that combine each of the plurality of metrics over a time period, wherein each of the number of compiled representations include a percentile value representation;
identifying a number of continuous segment intervals from the number of compiled representations; and
scheduling the task during at least one of the number of continuous segment intervals.

13. The method of claim 12, wherein identifying the number of continuous segment intervals comprises identifying segments of the number of compiled representations that transition from a position below the percentile value representation to a position above the percentile value representation.

14. The method of claim 12, wherein identifying the number of continuous segment intervals includes determining if an outlier series is greater than a particular percentile value representation within a particular segment.

15. The method of claim 12, wherein identifying the number of continuous segment intervals includes determining if an outlier series is less than a particular percentile value representation within a particular segment.
